(19) United States
(12) Patent Application Publication
(10) Pub. No.: US 2026/0169820 A1
(43) Pub. Date: Jun. 18, 2026

(54) DYNAMIC ALLOCATION OF SHARED MEMORY AND CACHE IN COMPUTE UNIT

(71) Applicants: ADVANCED MICRO DEVICES, INC., Santa Clara, CA (US); ATI TECHNOLOGIES ULC, Markham (CA)

(72) Inventors: Samuel Lawrence Wasmundt, San Diego, CA (US); Trinayan Baruah, San Diego, CA (US); Wilfred W. Kwok, Markham (CA); Randy Ramsey, Orlando, FL (US); Joseph L. Greathouse, Austin, TX (US)

(21) Appl. No.: 18/980,809

(22) Filed: Dec. 13, 2024

(51) Int. Cl. G06F 9/50; G06F 11/34

(52) U.S. Cl. CPC G06F 9/5072; G06F 9/5038; G06F 9/5044; G06F 11/3409

(57) ABSTRACT

A method includes dispatching an instruction to an accelerator unit including a plurality of compute units. Each compute unit of the plurality of compute units includes an adjustable memory configuration of a shared memory and a first level cache that are used by the various vector processors of the compute unit for executing one or more workgroups from the instruction. The method further includes allocating one or more workgroups from the instruction to one or more compute units of the plurality of compute units based on a memory configuration requirement for executing the one or more workgroups and a current state of the one or more compute units.

### BACKGROUND

Computing systems employ accelerator units (AUs), such as one or more graphics processing units (GPUs), artificial intelligence (AI) accelerators, or other parallel processors, to execute sets of instructions (also herein referred to as “threads”) from one or more applications running on a central processing unit (CPU) of the computing system. The threads can be grouped into “workgroups” which include operations to be executed by the compute units of the AU. To this end, an AU includes an array of compute units to execute workgroup operations in parallel to increase throughput and performance. In some cases, each compute unit includes a memory (e.g., a volatile memory such as a static random-access memory, SRAM) that is split into a shared memory (a local data share, LDS) and a first level cache. The on-site shared memory and the first level cache allow for quick data access that improves overall system performance.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example of a computing system with an accelerator unit (AU) having compute units (CUs) that are configured to allocate and reconfigure a shared memory and a first level cache, in accordance with some embodiments.

FIG. 2 shows an example of an AU, such as the AU of FIG. 1, configured to execute workgroups for applications running on a computing system, in accordance with some embodiments.

FIG. 3 shows an example of memory segments that are used to realize a shared memory and a first level cache in a CU, in accordance with some embodiments.

FIG. 4 shows an example flowchart describing a method to allocate workgroups to a compute unit based on a compute unit status and a memory configuration requirement, in accordance with some embodiments.

FIG. 5 shows an example flowchart describing a method to allocate workgroups to a compute unit and reconfigure a compute unit's split memory configuration including a shared memory and a first level cache, in accordance with some embodiments.

### DETAILED DESCRIPTION

An accelerator unit (AU) includes a compute unit (CU) array that executes workgroups associated with threads that are issued by an application running on a computing system. Each CU in the CU array includes scheduling circuitry or other front-end circuitry to receive threads from the CPU and schedule the threads into the workgroups for execution at the CU. The CUs include a series of vector processors, such as single-instruction, multiple-data (SIMD) units, that are configured to concurrently perform multiple instances of the same operations of a workgroup assigned to the CU. To store data used in the execution of the workgroup's operations, each one of CUs includes a local memory, such as an SRAM, which implements a shared memory (or LDS) and a first level cache. The LDS allows for efficient data sharing and communication between threads within the CU. For example, the SIMD units use the LDS as a scratch memory to store results of executing operations of the workgroup. The first level cache can include an instruction cache to store instructions associated with executing the workgroup at the SIMD units and/or a data cache to store data used in the execution of the workgroup at the SIMD units.

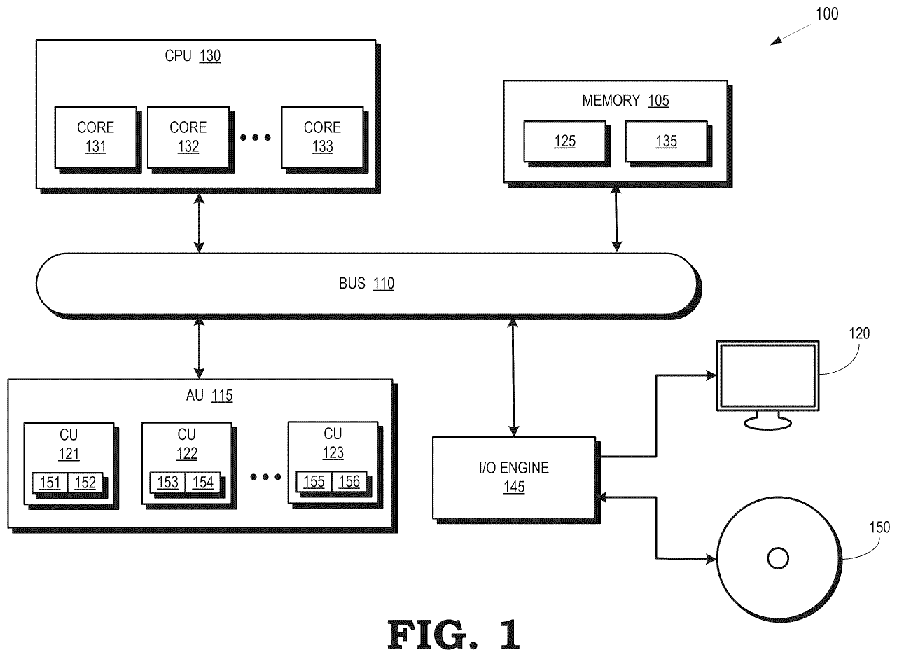

In some cases, the CU's SRAM includes a plurality of memory segments that are independently configurable such that one or more segments can be allocated as the LDS while the other segments are allocated as the first level cache. For example, if the CU includes five 64 kilobyte (KB) SRAM segments, the CU can allocate three SRAM segments (totaling 192 KB) as an LDS and two SRAM segments (totaling 128 KB) as a first level cache to execute a first workgroup whose resource demands require a 192 KB LDS or a 128 KB first level cache. To execute a second workgroup after the first workgroup that requires 256 KB first level cache, the CU can reconfigure the SRAM segments such that four of the SRAM segments operate as a first level cache and one SRAM segment operates as the LDS. However, the opportunity to reconfigure the memory segments may be dependent, at least in part, on a current state of the CU (i.e., whether the CU is currently executing another workgroup or in an idle state) and other considerations. FIGS. 1-5 provide techniques that dynamically reconfigure the CU's memory resources at runtime based on a current state of the CU and based on a memory configuration requirement to improve throughput and performance.

To illustrate, in one embodiment, a method includes dispatching one or more instructions (or threads) to an accelerator unit comprising a plurality of compute units. For example, a CPU may issue the one or more instructions to the accelerator unit responsive to executing a machine learning application or a graphics application. Each compute unit of the accelerator unit includes an adjustable memory configuration with a shared memory (such as an LDS) and a first level cache (such as a data cache). The accelerator unit includes processing circuitry that allocates one or more workgroups from the one or more instructions to a compute unit of the plurality of compute units based on a memory configuration requirement for executing the one or more workgroups and a current state of the compute unit. For example, in some embodiments, the memory configuration requirement is based on a hint provided in the instruction or based on runtime statistics and performance data of the plurality of compute units. The hint provided in the instruction may indicate a requirement or a preference for a certain amount (e.g., 0 KB, 100 KB, etc.) of LDS or a certain amount (e.g., 0 KB, 100 KB, etc.) of first level cache. The current state of the compute unit is, for example, an idle state or an underutilized state. If the compute unit is in the idle state or the underutilized state, then the accelerator unit reconfigures the adjustable memory configuration of the compute unit to modify the proportion of memory allocated to each of the LDS and the first level cache based on the memory configuration requirement. In this manner, the memory shared between the LDS and the first level cache in each compute unite is reconfigured to improve the efficiency of executing operations associated with one or more workgroups depending on the compute unit's current state (e.g., whether the CU is currently executing operations associated with another workgroup), the workgroup memory requirements, and the CU's processing and memory bandwidth capabilities.

In some embodiments, any of the elements, components, or blocks shown in the ensuing figures are implemented as one of software executing on a processor, hardware that is hard-wired (e.g., circuitry) to perform the various operations described herein, or a combination thereof. For example, one or more of the described blocks or components associated with the techniques described herein represent software instructions that are executed by hardware such as a digital signal processor (DSP), an application-specific integrated circuit (ASIC), a set of logic gates, a field programmable gate array (FPGA), a programmable logic device (PLD), a hardware accelerator, a graphics processing unit (GPU), a neural network (NN) accelerator, an artificial intelligence (AI) accelerator, or other type of hardcoded or programmable circuitry.

FIG. 1 shows an example of a processing system 100 to implement the dynamic allocation and reconfiguration of memory storage capacity between a shared memory (such as an LDS) and a first level cache of a compute unit according to some embodiments. The processing system 100 includes or has access to a memory 105 or other storage component that is implemented using a non-transitory computer readable medium such as a dynamic random-access memory (DRAM). However, in some cases, the memory 105 is implemented using other types of memory including static random-access memory (SRAM), nonvolatile RAM, and the like. In some cases, the memory 105 is referred to as an external memory since it is implemented external to the processing units (e.g., the CPU 130 and the AU 115) implemented in the processing system 100. The processing system 100 also includes a bus 110 to support communication between entities implemented in the processing system 100, such as the memory 105. Some embodiments of the processing system 100 include other buses, bridges, switches, routers, and the like, which are not shown in FIG. 1 in the interest of clarity.

The techniques described herein are, in different embodiments, employed at any of a variety of accelerator units (e.g., parallel processors, vector processors, graphics processing units (GPUs), general-purpose GPUs (GPGPUs), non-scalar processors, highly-parallel processors, artificial intelligence (AI) processors, neural network (NN) accelerators, inference engines, machine learning processors, other multithreaded processing units, and the like). FIG. 1 illustrates an example of an accelerator unit (AU) 115, in accordance with some embodiments. The AU 115, in some embodiments, is a GPU that renders images for presentation on a display 120 or that executes computations in an artificial intelligence (AI) model such as a machine learning (ML) model. For example, the AU 115 renders objects to produce values of pixels that are provided to the display 120, which uses the pixel values to display an image that represents the rendered objects. The AU 115 includes a plurality of compute units (CU) 121, 122, 123 (collectively referred to herein as “the compute units (CUs) 121-123”) that execute instructions concurrently or in parallel. In some embodiments, each one of the CUs 121-123 includes one or more single instruction, multiple data (SIMD) units, and the CUs 121-123 are aggregated into workgroup processors, shader arrays, shader engines, or the like. The number of CUs 121-123 implemented in the AU 115 is a matter of design choice and some embodiments of the AU 115 include more or fewer compute units than shown in FIG. 1. In some embodiments, the CUs 121-123 include an internal memory (e.g., an SRAM) that implements a shared memory (e.g., an LDS) and a first level cache. For example, the CU 121 includes an LDS 151 and a first level cache 152, the CU 122 includes an LDS 153 and a first level cache 154, and the CU 123 includes an LDS 155 and a first level cache 156.

In some embodiments, each of the respective LDSs 151, 153, 155 allow for efficient data sharing and communication between threads within the respective CU. For example, the SIMD units in a respective one of the CUs 121, 122, 123 use the respective LDS as a scratch memory to store results of executing operations. In some embodiments, each of the respective first level caches 152, 154, 156 includes at least one of an instruction cache to store instructions associated with executing the workgroup at the SIMD units and a data cache to store data used in the execution of the workgroup at the SIMD units in a respective one of the CUs 121, 122, 123.

In some embodiments, the AU 115 is used for general purpose computing, graphics rendering operations, or compute operations for executing an AI model. For example, the AU 115 executes instructions such as the program code 125 stored in the memory 105 and the AU 115 stores information in the memory 105 such as the results of the executed instructions. The AU 115, as another example, executes instructions for an application 135 stored in the memory 105 and executed by the CPU 130.

In some embodiments, the AU 115 executes commands and programs for selected functions, such as graphics operations, machine learning operations, and other operations that are particularly suited for parallel processing. For example, the AU 115 is used for executing graphics pipeline operations, such as pixel operations, geometric computations, and rendering an image to a display. In some embodiments, AU 115 also executes compute processing operations (e.g., those operations unrelated to graphics such as video operations, physics simulations, computational fluid dynamics, etc.) based on commands or instructions received from the CPU 130. For example, such commands include special instructions that are not typically defined in the instruction set architecture (ISA) of the AU 115. In some embodiments, the AU 115 receives an image geometry representing a graphics image, along with one or more commands or instructions for rendering and displaying the image. In various embodiments, the image geometry corresponds to a representation of a two-dimensional (2D) or three-dimensional (3D) computerized graphics image.

The processing system 100 also includes a central processing unit (CPU) 130 that is connected to the bus 110 and therefore communicates with the AU 115 and the memory 105 via the bus 110. The CPU 130 implements a plurality of processor cores 131, 132, 133 (collectively referred to herein as “the processor cores 131-133”) that execute instructions concurrently or in parallel. The number of processor cores 131-133 implemented in the CPU 130 is a matter of design choice and some embodiments include more or fewer processor cores than illustrated in FIG. 1. The processor cores 131-133 execute instructions such as program code 125 stored in the memory 105 and the CPU 130 stores information in the memory 105 such as the results of the executed instructions. The CPU 130 is also able to initiate graphics processing by issuing draw calls to the AU 115. Some embodiments of the CPU 130 implement multiple processor cores (not shown in FIG. 1 in the interest of clarity) that execute instructions concurrently or in parallel.

An input/output (I/O) engine 145 handles input or output operations associated with the display 120, as well as other elements of the processing system 100 such as keyboards, mice, printers, external disks, and the like. The I/O engine 145 is coupled to the bus 110 so that the I/O engine 145 communicates with the memory 105, the AU 115, or the CPU 130. In the illustrated embodiment, the I/O engine 145 reads information stored on an external storage component 150, which is implemented using a non-transitory computer readable medium such as a compact disk (CD), flash drive, and the like. The I/O engine 145 is also able to write information to the external storage component 150, such as the results of processing by the AU 115 or the CPU 130.

In various embodiments, processing system 100 is a computer, laptop, mobile device, server, or any of various other types of computing systems or devices. It is noted that the number of components of processing system 100 can vary from embodiment to embodiment. There can be more or fewer of each component or subcomponent than the number shown in FIG. 1. Additionally, in some embodiments, the processing system 100 includes other components that are not shown in FIG. 1 or can be structured in other ways than shown in FIG. 1.

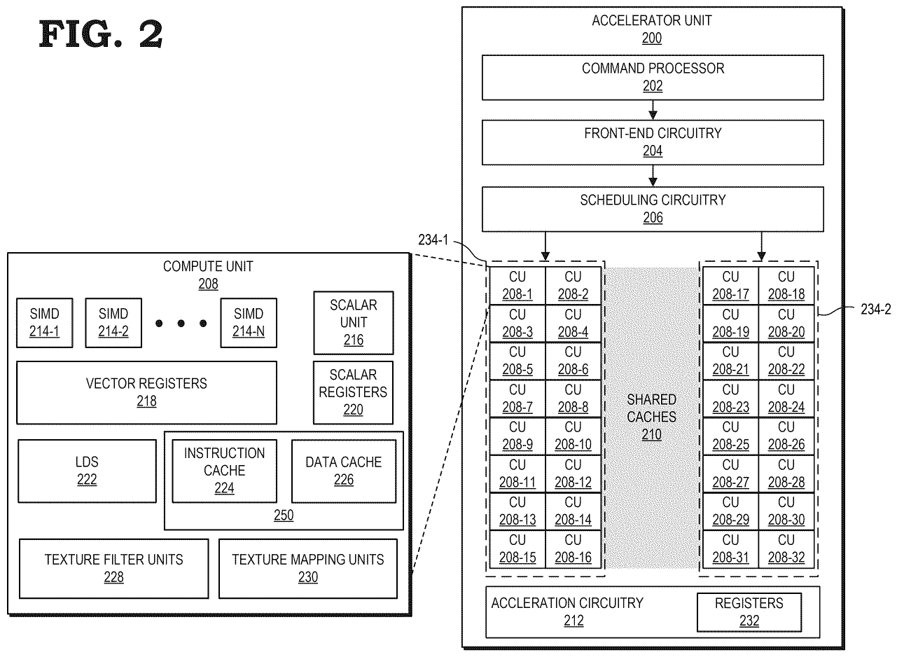

FIG. 2 shows an example of an accelerator unit (AU) 200, such as one corresponding to the AU 115 of FIG. 1, configured to execute workgroups for one or more applications running on a processing system. These applications include, for example, compute applications, graphics applications, or both each configured to issue respective series of instructions (or threads) to a CPU of the processing system. Compute applications, when executed by a processing system, cause the processing system to perform one or more computations, such as machine-learning, neural network, high-performance computing, or databasing computations. Further, graphics applications, when executed by a processing system, cause the processing system to render a scene including one or more graphics objects and, as an example, output the scene on a display. The instructions issued to the CPU from these applications, for example, include groups of threads (or workgroups) to be executed by AU 200. To execute these workgroups, AU 200 includes one or more vector processors, coprocessors, graphics processing units (GPUs), general-purpose GPUs, non-scalar processors, highly parallel processors, artificial intelligence (AI) processors, inference engines, machine-learning processors, or any combination thereof. As an example, AU 200 includes one or more command processors 202, front-end circuitry 204, scheduling circuitry 206, compute units 208, shared caches 210, and acceleration circuitry 212.

A command processor 202 of AU 200 is configured to receive a command stream from the CPU indicating one or more workgroups to be executed. As an example, based on a compute application running on the processing system, the command processor 202 receives a command stream indicating workgroups that require compute operations such as matrix multiplication, addition, subtraction, and the like to be performed. As another example, based on a graphics application running on the processing system, the command processor 202 receives a command stream indicating workgroups that include draw calls for a scene to be rendered. After receiving a command stream, the command processor 202 parses the command stream and issues respective instructions of the indicated workgroups to the front-end circuitry 204, the scheduling circuitry 206, or both. As an example, based on a command stream from a graphics application, the command processor 202 issues one or more draw calls to the front-end circuitry 204 that includes one or more vertex shaders, polygon list builders, and the like. From the instructions issued from the command processor 202, the front-end circuitry 204 is configured to position geometry objects in a scene, assemble primitives in a scene, cull primitives, perform visibility passes for primitives in a scene, generate visible primitive lists for a scene, or any combination thereof. For example, based on a set of draw calls received from a command processor 202, the front-end circuitry 204 determines a list of primitives to be rendered for a scene. After determining a list of primitives to be rendered for a scene, the front-end circuitry 204 issues one or more draw calls (e.g., a workgroup) associated with the primitives in the list of primitives to the scheduling circuitry 206.

Based on the instructions of the workgroups received from the command processor 202, the front-end circuitry 204, or both, the scheduling circuitry 206 is configured to provide data indicating threads (e.g., operations for these threads) to be executed for these workgroups to one or more compute units 208. Each compute unit (CU) 208 is configured to support the concurrent execution of two or more threads of a workgroup. For example, each compute unit 208 is configured to concurrently execute a predetermined number of threads referred to herein as a “wavefront.” Based on the size of the wavefront, the scheduling circuitry 206 schedules one or more groups of threads of the wavefront, also referred to herein as “waves,” to be executed by the compute unit 208. As an example, the scheduling circuitry 206 first updates one or more registers of a compute unit 208 such that the compute unit 208 is configured to execute a first group of waves of the workgroup. After the compute unit 208 has executed the first group of waves, the scheduling circuitry 206 updates one or more registers of the compute unit 208 to schedule a second group of waves of the workgroup to be executed by the compute unit 208. To execute these waves, each compute unit is connected to one or more shared caches 210 that each include a volatile memory, non-volatile memory, or both accessible by one or more compute units 208. These shared caches 210, for example, are configured to store data (e.g., register files, values, operands, instructions, variables) used in the execution of one or more waves, data resulting from the performance of one or more waves, or both. Because a shared cache 210 is accessible by two or more compute units 208, a first compute unit 208-1 is enabled to provide results from the execution of a first wave to a second compute unit 208-2 executing a second wave. Though the example embodiment illustrated in FIG. 2 shows the AU 200 as including 32 compute units (208-1 to 208-32), in other implementations, the AU 200 can include any number of compute units 208.

In some embodiments, each compute unit 208 includes one or more single instruction, multiple data (SIMD) units 214, a scalar unit 216, vector registers 218, scalar registers 220, a local data share (LDS) 222, an instruction cache 224, a data cache 226, texture filter units 228, texture mapping units 230, or any combination thereof. A SIMD unit 214 (e.g., a vector processor) is configured to concurrently perform multiple instances of the same operation for a wave. For example, a SIMD unit 214 includes two or more lanes each including an arithmetic logic unit (ALU) and each configured to perform the same operation for the threads of a wave. Though the illustrated embodiment presented in FIG. 2 shows a compute unit 208 including three SIMD units (214-1, 214-2, 214-N) representing an N number of SIMD units, in other implementations, a compute unit 208 can include any number of SIMD units 214. Further, as an example, the size of a wavefront supported by AU 200 is based on the number of SIMD units 214 included in each compute unit 208 and the number of compute units 208 in the AU 200. To determine the operations performed by the SIMD units 214, each compute unit 208 includes vector registers 218 formed from one or more physical registers of AU 200. These vector registers 218 are configured to store data (e.g., operands, values) used by the respective lanes of the SIMD units 214 to perform a corresponding operation for the wave. Additionally, each compute unit 208 includes a scalar unit 216 configured to perform scalar operations for the wave. As an example, the scalar unit 216 includes an ALU configured to perform scalar operations. To support the scalar unit 216, each compute unit 208 includes scalar registers 220 formed from one or more physical registers of accelerator unit 200. These scalar registers 220 store data (e.g., operands, values) used by the scalar unit 216 to perform a corresponding scalar operation for the wave.

Further, each compute unit 208 includes an LDS 222 formed from a volatile memory (e.g., SRAM) accessible by each SIMD unit 214 and the scalar unit 216 of the compute unit 208. That is to say, the LDS 222 is shared across each wave concurrently executing on the compute unit 208. The LDS 222 is configured to store data resulting from the execution of one or more operations for one or more waves, data (e.g., register files, values, operands, instructions, variables) used in the execution of one or operations for one or more waves, or both. As an example, the LDS 222 is used as a scratch memory to store results necessary for, aiding in, or helpful for the performance of one or more operations by one or more SIMD units 214. The instruction cache 224 of a compute unit 208, for example, includes a volatile memory, non-volatile memory, or both configured to store the instructions to be executed for one or more waves to be executed by the compute unit 208. Further, the data cache 226 of a compute unit 208 includes a volatile memory, non-volatile memory, or both configured to store data (e.g., register files, values, operands, variables) used in the execution of one or more waves by the compute unit 208. In some embodiments, the instruction cache 224, the data cache 226, or a combination thereof, are herein referred to as a first level cache 250 of the compute unit 208.

The instruction cache 224, data cache 226, shared caches 210, and a system memory (e.g., memory 105 of FIG. 1), for example, are arranged in a hierarchy based on the respective sizes of the caches. As an example, based on such a cache hierarchy, a compute unit 208 first requests data from a controller of a corresponding data cache 226. Based on the data not being in the data cache 226, the data cache 226 requests the data from a shared cache 210 at the next level of the cache hierarchy. The caches then continue in this way until the data is found in a cache or requested from the system memory, at which point, the data is returned to the compute unit 208. Additionally, each compute unit 208 includes one or more texture mapping units 230 each including circuitry configured to map textures to one or more graphics objects (e.g., groups of primitives) generated by the compute units 208. Further, each compute unit 208 includes one or more texture filter units 228 each having circuitry configured to filter the textures applied to the generated graphics objects. For example, the texture filter units 228 are configured to perform one or more magnification operations, anti-aliasing operations, or both to filter a texture.

Additionally, to help perform instructions for one or more workgroups, the AU 200 includes an acceleration circuitry 212. Such acceleration circuitry 212 includes hardware (e.g., fixed-function hardware) configured to execute one or more instructions for one or more workgroups. As an example, acceleration circuitry 212 includes one or more instances of fixed function hardware configured to encode frames, encode audio, decode frames, decode audio, display frames, output audio, perform matrix multiplication, or any combination thereof. To schedule instructions for execution on such hardware, the scheduling circuitry 206 is configured to update one or more physical registers 232 of the AU 200 associated with the hardware. In some cases, the AU 200 includes one or more compute units 208 grouped into one or more shader engines 234. Referring to the embodiment illustrated in FIG. 2, for example, the AU 200 includes compute units 208-1 to 208-16 grouped in a first shader engine 234-1 and compute units 208-17 to 208-32 grouped in a second shader engine 234-2. Such shader engines 234, for example, are configured to execute one or more workgroups (e.g., one or more compute kernels) for an application and include one or more compute units 208, graphics processing hardware (e.g., primitive assemblers, rasterizers), one or more shared caches 210, render backends, or any combination thereof. Though the embodiment illustrated in FIG. 2 shows the AU 200 as including two shader engines (234-1, 234-2), in other implementations, the AU 200 can include any number of shader engines.

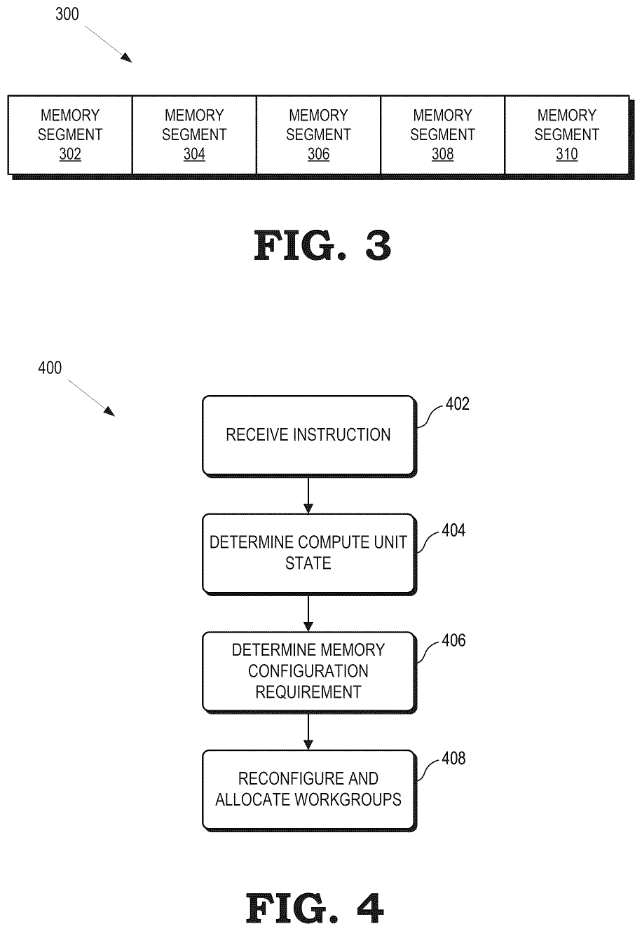

In some embodiments, the compute unit 208 includes an internal volatile memory, e.g., static random-access memory (SRAM). The internal volatile memory includes multiple memory segments to implement the LDS 222 and the first level cache (the instruction cache 224, the data cache 226, or a combination thereof). FIG. 3 shows an example of an SRAM 300 with multiple SRAM segments 302, 304, 306, 308, 310 that operate as an adjustable memory configuration including an LDS (such as the LDS 222 of FIG. 2) and a first level cache (such as the data cache 226 of FIG. 2) in a compute unit (such as the compute unit 208 of FIG. 2). Though the example embodiment illustrated in FIG. 3 shows the SRAM 300 as including five memory segments (302, 304, 306, 308. 310), in other implementations, the SRAM 300 can include any number of memory segments.

In some embodiments, each of the memory segments 302, 304, 306, 308, 310 are the same size. For example, in some embodiments, each one of the memory segments 302, 304, 306, 308, 310 has a capacity of 64 KB. In other embodiments, the memory segments 302, 304, 306, 308, 310 are another size (e.g., 128 KB). In yet other embodiments, the memory segments are different sizes (e.g., the memory segments 302, 304, 306 are 64 KB and the memory segments 308, 310 are 128 KB). The SRAM 300 is configurable so that the memory segments 302, 304, 306, 308, 310 can operate as either a shared memory (e.g., the LDS 222 of FIG. 3) or as the first level cache (e.g., the data cache 226 of FIG. 2) in a compute unit. That is to say, depending on the demands of the work group(s) to be executed at the compute unit, the compute unit (e.g., via a hint passed on by the scheduling circuitry 206 of the AU 200) is configured to allocate a number of the memory segments 302, 304, 306, 308, 310 as the LDS or as the first level cache. For example, if each SRAM memory segment 302, 304, 306, 308 has a capacity of 64 KB and a particular workgroup's demands require a minimum capacity of 100 KB LDS and a minimum capacity of 150 KB first level cache at the compute unit, then the compute unit configures the SRAM 300 so that two of the memory segments (e.g., the memory segment 302, 304) function as the LDS and three of the memory segments (e.g., the memory segments 306, 308, 310) function as the first level cache.

Referring back to FIG. 2, in some embodiments, each one of the compute units 208 executes operations associated with one or more workgroups issued by an application running on a CPU (e.g., CPU 130 of FIG. 1) at any given time. In some cases, a compute unit 208 can execute one workgroup at a time or, in other cases, a compute unit 208 can execute multiple workgroups concurrently. In some cases, the workgroups themselves have the same, similar, or different resource needs (e.g., first level cache and LDS requirements) as well as having the same, similar, or different characteristics (e.g., runtime length, priority, or the like). The overall performance of the AU 200 is impacted by different factors including, for example, AU occupancy and kernel execution times. Some programs have varying shared memory needs which can directly limit the AU occupancy and motivate a larger shared memory configuration in the compute units 208. On the other hand, workloads that execute concurrently on a compute unit 208 may seek to leverage the internal cache hierarchy to bring data in from memory to the first level cache and thus can benefit from a larger first level cache size that allows for larger working set data to stay resident within the first level cache. As such, for a compute unit architecture with a single data RAM for both the shared memory and the first level cache, there may be resource contention between the shared memory and the first level cache. Furthermore, the optimal configuration can dynamically change based on the demands of the one or more workgroups running on the compute unit at a given point in time.

In some embodiments, the methods and devices described herein provide techniques to dynamically control the split between the shared memory (e.g., the LDS 222) and the first level cache (e.g., the data cache 226) in the compute unit 208. To illustrate, there are multiple pipelines that drive workgroups to the compute units 208 of the accelerator unit 200. For example, one pipeline includes the scheduling circuitry 206 driving workgroups to the first shader engine 234-1 and another pipeline can include the scheduling circuitry 206 driving workgroups to a second shader engine 243-2. In some embodiments, each of these pipelines driving workgroups to the compute units 208 can have different workload characteristics that need (or, alternatively, that requires via programmer hints) different shared memory (e.g., LDS 222) and first level cache (e.g., data cache 226) configuration splits. Thus, the methods and devices described herein provide techniques that determine the split between the shared memory (e.g., LDS 222) and the first level cache (e.g., data cache 226) based on a memory configuration requirement (e.g., provided by programmer hint) and based on a compute unit runtime information such as a current state of the compute unit.

In some embodiments, the techniques described herein introduce a dynamic memory reconfiguration scheme that seeks to maximize workgroup occupancy. In some cases, the maximization of workgroup occupancy is done independently within a compute unit 208 (i.e., per compute unit) by assessing the dispatch of the accelerator unit's scheduling circuitry (e.g., the scheduling circuitry 206) and taking a maximum suggested shared memory or first level cache value needed in each compute unit of a shader engine 234 as indicated by the dispatch. For example, in some cases, the scheduling circuitry 206 tracks a hint provided in the instruction or thread received at the AU 200 and asymptotically increases the shared memory or the first level cache size in a compute unit 208 (or alternatively, in a first set of the compute units 208 such as the shader engine 234-1) until the compute unit 208 reaches the maximum suggested value of the shared memory or the first level cache. Once the maximum suggested value of the shared memory or the first level cache is reached, in some embodiments, the amount of the shared memory or the first level cache is reverted back to a default configuration. On coming out of the state with the maximum suggested value of the shared memory or the first level cache, if the active one or more compute units receive a subsequent hint indicating a shared memory or a first level cache value of less than the default configuration, the compute unit 208 sets the ratio of the shared memory to the first level cache (or vice versa) accordingly. In some cases, if there is no hint in the dispatch from the scheduling circuitry 206 or if the hint indicates a shared memory that is less than the required shared memory for dispatch to a compute unit 208, then the compute unit 208 is configured to implement an override that maintains forward progress for executing the workgroup.

FIG. 4 shows an example of a flowchart 400 in accordance with some embodiments. The flowchart 400 describes a method to allocate workgroups to a compute unit in an accelerator unit (such as the accelerator unit 200 of FIG. 2) based on a compute unit status and a memory configuration requirement.

At block 402, a scheduling circuitry (such as the scheduling circuitry 206 of FIG. 2) in an accelerator unit (such as the accelerator unit 200 of FIG. 2) receives an instruction (or thread). For example, the scheduling circuitry receives the instruction from a command processor (such as the command processor 202 of FIG. 2) in response to the command processor receiving a command stream and parsing the command stream into a set of one or more instructions including the instruction.

At block 404, the accelerator unit determines the state of one or more compute units in the accelerator unit. For example, the accelerator unit (such as the accelerator unit 200 of FIG. 2) monitors the state of the compute units (such as the compute units 208 of FIG. 2). This monitoring may, for example, include determining whether the compute unit is in a fully occupied state, idle state, or underutilized state. The fully occupied state, for example, indicates that the compute unit's resources (e.g., LDS or data cache) are currently being used to execute one or more other workgroups, which indicates that the resources currently cannot be reconfigured to support the execution of a current workgroup. The underutilized state, for example, indicates that while the compute unit's resources are currently being used to execute one or more other workgroups, the compute unit has sufficient bandwidth to accommodate the execution of an additional workgroup and (potentially) reconfigure its resources (e.g., LDS or first level cache) to accommodate the additional workgroup (e.g., as long as the reconfiguration does not interfere with the currently executing workgroup). The idle state, for example, indicates that the compute unit is currently not being used.

At block 406, the accelerator unit determines a memory configuration requirement of one or more workgroups from the instruction received at 402. In some embodiments, to determine the memory configuration requirement, the scheduling circuitry 206 (or alternatively, the command processor 202 or the front-end circuitry 204) reads a programmer hint provided in the instruction received at 402. The hint, for example, may include a preference for a particular allocation of shared memory (such as the LDS 222 of FIG. 2), a first level cache (such as the data cache 226 of FIG. 2), or both. In another example, the hint may be a requirement for a particular allocation of a shared memory, a first level cache, or both. In some embodiments, the memory configuration requirement is based on runtime statistics and performance data of the compute units. For example, the runtime statistics and performance data of the compute units include accelerator unit occupancy data and an average workgroup runtime (or execution time).

The embodiment illustrated in flowchart 400 shows block 406 occurring after block 404. In other embodiments, block 406 occurs before or concurrently with block 404.

At block 408, the accelerator unit reconfigures one or more compute units based on the determined compute unit state and the memory configuration requirement and allocates one or more workgroups to each of the one or more reconfigured compute units.

Thus, the method described in flowchart 400 dynamically reconfigures a compute unit's split memory configuration (including an LDS and a first level cache, for example) based on the current state of the compute unit and the memory configuration requirement for executing a workgroup at the compute unit to more efficiently execute the workgroup's operations.

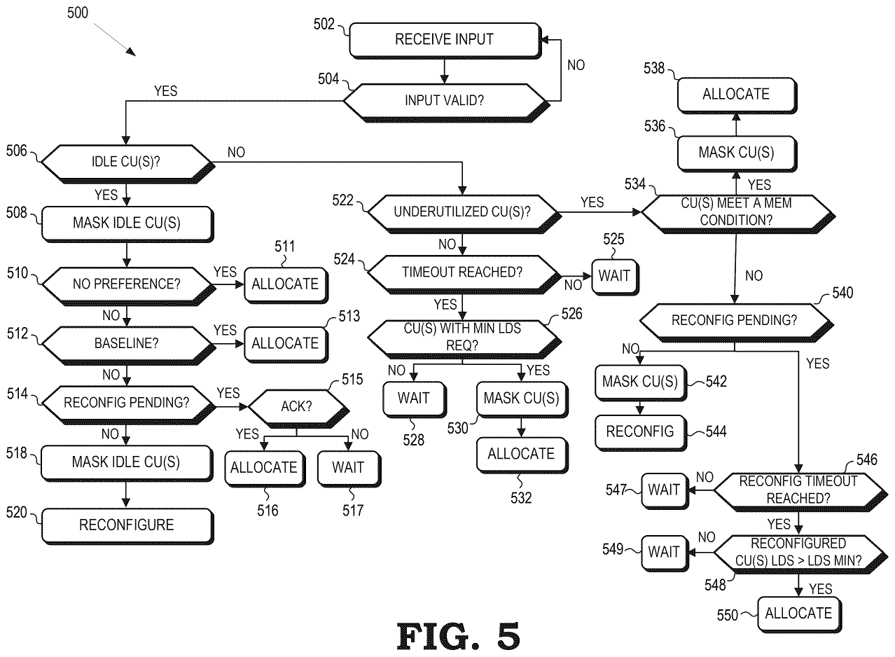

FIG. 5 shows an example of a flowchart 500 in accordance with some embodiments. The flowchart 500 describes a method to allocate workgroups to a compute unit in an accelerator unit (such as the accelerator unit 200 of FIG. 2) based on a compute unit status and a memory configuration requirement.

At block 502, the scheduling circuitry (such as the scheduling circuitry 206 of FIG. 2) in the accelerator unit receives an input such as an instruction or thread with one or more workgroups.

At block 504, the scheduling circuitry determines if the input is valid. In some embodiments, this includes the scheduling circuitry determining whether a hint provided in the instruction includes an LDS requirement that can be supported by the compute units. For example, if the hint indicates an LDS requirement of 500 KB, but the compute units have a 400 KB maximum LDS, then the input is determined to be invalid, and the instruction is not launched.

If the input is valid at block 504 (i.e., YES at block 504), then at block 506, the accelerator unit determines if there are idle compute units (or compute units that are not currently executing another workgroup).

If there are idle compute units (YES at block 506), then the method proceeds to block 508 where the accelerator unit applies a mask to the idle compute units. At block 510, the scheduling circuitry in the accelerator unit checks the hints provided in the received instruction to determine if there is a preference for a particular memory configuration (e.g., a certain allocation of LDS or first level cache). If there is no preference (i.e., YES at block 510), then at block 511, the scheduling circuitry attempts to allocate the workgroup(s) to the masked compute units in their current memory configuration. If there is an indication of a preference (i.e., NO at block 510), then at block 512, the scheduling circuitry checks if the masked compute unit(s) are in the baseline configuration provided in the hint. For example, the baseline configuration provided in the hint, in some embodiments, defines a particular amount of LDS and/or first level cache, e.g., 100 KB LDS and 300 KB first level cache. If the masked idle compute unit(s) are already in the baseline configuration (i.e., YES at block 512), then the scheduling circuitry attempts the allocation of the workgroup(s) to the masked idle compute units in their current memory configuration at block 513. If the masked idle compute unit(s) are not in the baseline configuration (i.e., NO at block 512), then the scheduling circuitry determines if there is a pending reconfiguration of the memory configuration in the masked idle compute units at block 514. If there is not a pending reconfiguration (i.e., NO at block 514), the accelerator unit applies a second mask to the masked idle compute unit(s) at block 518 and reconfigures their split memory configuration (e.g., the split between the LDS and the first level cache) at block 520. If there is a pending reconfiguration (i.e., YES at block 514), then the scheduling circuitry determines if an acknowledgement (ACK) has been received from the compute unit to indicate that the reconfiguration is complete at block 515. If the ACK is received (i.e., YES at block 515), then the scheduling circuitry attempts the allocation of the workgroup(s) to the compute units at block 516. If the ACK has not been received (i.e., NO at block 515), then the scheduling circuitry waits to allocate the workgroups at block 517.

Referring back to block 506, if the accelerator unit determines that there are not any idle compute units (i.e., NO at block 506), then the accelerator unit at block 522 determines if there are any underutilized compute units. In some embodiments, underutilized compute units are those that are currently executing one or more other workgroups but have the computing and memory bandwidth to execute additional workgroups.

If there are underutilized computes units (i.e., YES at block 522), the accelerator unit (e.g., via the scheduling circuitry) assesses whether the underutilized compute units meet one or more memory requirement conditions at block 534. In some embodiments, the one or more conditions include at least one of determining whether the underutilized computes units meet a baseline configuration (e.g., similar to that described above at block 512) or whether the compute units have the computing bandwidth to manage the execution of the additional workgroup based on the compute unit's current utilized state. If the compute units meet the one or more conditions (i.e., YES at block 534), the scheduling circuitry at block 536 masks the compute units meeting the condition(s) and allocates the workgroups to the masked compute units at block 538. If the compute units do not meet the one or more conditions (i.e., NO at block 524), the scheduling circuitry at block 540 assesses whether there is a pending reconfiguration of the compute units. If there is no reconfiguration pending (i.e., NO at block 540), then the scheduling circuitry masks the underutilized computes units at block 542 and reconfigures the split memory configuration (e.g., the allocation of LDS to first level cache, or vice versa) in the masked compute units at block 544. If there is a reconfiguration pending (i.e., YES at block 540), the scheduling circuitry proceeds to block 546 to determine if a reconfiguration timeout has been reached. The reconfiguration timeout, in some embodiments, is a duration of time that is set by a programmer, by an application, by the accelerator unit, or by workgroups currently being executed at the underutilized compute units, for example. If the reconfiguration timeout has not been reached (i.e., NO at block 546), then the scheduling circuitry waits until the timeout is reached at 547. If the reconfiguration timeout is reached (i.e., YES at block 546), the scheduling circuitry assesses whether the LDS of the reconfigured and underutilized compute units is larger than a minimum LDS requirement to execute the workgroup(s) at block 548. If not (i.e., NO at block 548), the scheduling circuitry waits to allocate the workgroups. If it is (i.e., YES at block 548), the scheduling circuitry allocate the workgroups to the underutilized compute units at block 550.

Referring back to block 522, if there are no underutilized compute units (i.e., NO at block 522), the scheduling circuitry at block 524 waits to see if a second timeout has been reached. If the timeout has not been reached (i.e., NO at block 524), the scheduling circuitry waits until the timeout is reached at block 525. If the timeout has been reached (i.e., YES at block 524), then the scheduling circuitry at block 526 assesses whether the compute unit(s) are currently configured with the minimum LDS requirement (e.g., as indicating in a programmer hint) to execute the workgroup(s). If not (i.e., NO at block 526), then the scheduling circuitry waits at block 528. If the compute unit(s) are configured with the minimum LDS requirement, then the scheduling circuitry masks those compute unit(s) configured with the minimum LDS requirement at block 532 and allocates the workgroups at block 532 accordingly.

The embodiments described above discuss dynamically reconfiguring the split between shared memory and the first level cache in a compute unit of an accelerator unit at a compute unit granularity. That is, the embodiments described above discuss implementing the dynamic memory reconfiguration techniques at the per-compute unit level. In other embodiments, the techniques described herein are similarly implemented for a group of compute units. For example, the techniques described herein can similarly be applied for a set of 8 compute units (e.g., the CU 208-1 to the CU 208-8 of FIG. 2), for an entire set of compute units in a shader engine (e.g., the CU 208-1 to the CU 208-16 of the shader engine 2341-1 of FIG. 2), or for all of the compute units in an accelerator unit (e.g., the CU 208-1 to the CU 208-32 of accelerator unit 200 of FIG. 2).

In some embodiments, the apparatus and techniques described above are implemented in a system including one or more integrated circuit (IC) devices (also referred to as integrated circuit packages or microchips), such as the APUs described above with reference to FIGS. 1-5. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry, etc.) are described or claimed as “configured” to perform one or more tasks or operations. This formulation-[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving an instruction at an accelerator unit comprising a plurality of compute units, wherein each compute unit of the plurality of compute units comprises an adjustable memory configuration of a shared memory and a first level cache; and
allocating one or more workgroups from the instruction to one or more compute units of the plurality of compute units based on a memory configuration requirement for executing the one or more workgroups and a current state of the one or more compute units.

2. The method of claim 1, wherein the memory configuration requirement indicates a minimum capacity of the shared memory or of the first level cache, and the method further comprises:
executing the one or more workgroups at the one or more compute units responsive to allocating the one or more workgroups.

3. The method of claim 1, wherein the memory configuration requirement comprises a hint provided in the instruction.

4. The method of claim 1, wherein the memory configuration requirement comprises runtime statistics and performance data of the one or more compute units.

5. The method of claim 1, wherein the runtime statistics and the performance data comprise an occupancy data and an average workgroup runtime.

6. The method of claim 1, wherein allocating the one or more workgroups to the one or more compute units comprises:
selecting the one or more compute units from the plurality of compute units based on the one or more compute units being in a first state; and
responsive to the one or more compute units being in the first state, allocating the one or more workgroups to the one or more compute units based on whether one or more conditions are satisfied.

7. The method of claim 6, wherein the first state is an idle state indicating that the one or more compute units are not currently executing a workgroup or an underutilized state indicating that the one or more compute units have bandwidth to execute an additional workgroup.

8. The method of claim 6, wherein the one or more conditions comprise at least one of:
a first condition indicating no preference for the adjustable memory configuration, or
a second condition indicating a baseline for the adjustable memory configuration.

9. The method of claim 6, wherein based on the one or more conditions not being satisfied, the method further comprises:
detecting whether a reconfiguration of the adjustable memory configuration at the one or more compute units is pending; and
responsive to detecting that the reconfiguration is not pending, reconfiguring the adjustable memory configuration of the one or more compute units based on the memory configuration requirement.

10. The method of claim 9, responsive to detecting that the reconfiguration is pending:
attempting to allocate the one or more workgroups responsive to receiving an acknowledgement that the reconfiguration is pending.

11. An accelerator unit comprising:
a plurality of compute units, wherein each compute unit of the plurality of compute units comprises an adjustable memory configuration of a shared memory and a first level cache; and
scheduling circuitry configured to:
allocate one or more workgroups from an instruction to one or more compute units of the plurality of compute units based on a memory configuration requirement for executing the one or more workgroups and a current state of the one or more compute units.

12. The accelerator unit of claim 11, wherein the memory configuration requirement indicates a minimum capacity of the shared memory or of the first level cache, and the one or more compute units are configured to execute the one or more workgroups.

13. The accelerator unit of claim 11, wherein the memory configuration requirement comprises a hint provided in the instruction.

14. The accelerator unit of claim 11, wherein the memory configuration requirement comprises runtime statistics and performance data of the one or more compute units.

15. The accelerator unit of claim 11, wherein the scheduling circuitry is configured to:
select the one or more compute units from the plurality of compute units based on the one or more compute units being in a first state; and
responsive to the one or more compute units being in the first state, allocate the one or more workgroups to the one or more compute units based on whether one or more conditions are satisfied.

16. The accelerator unit of claim 15, wherein the first state is an idle state indicating that the one or more compute units are not currently executing a workgroup or an underutilized state indicating that the one or more compute units have bandwidth to execute an additional workgroup.

17. The accelerator unit of claim 15, wherein based on the one or more conditions not being satisfied, the scheduling circuitry is configured to:
detect whether a reconfiguration of the adjustable memory configuration at the one or more compute units is pending; and
responsive to detecting that the reconfiguration is not pending, reconfigure the adjustable memory configuration of the one or more compute units based on the memory configuration requirement.

18. A compute unit comprising:
an adjustable memory configuration of a shared memory and a first level cache; and
processing circuitry configured to:
execute one or more workgroups of an instruction based on the adjustable memory configuration satisfying a memory configuration requirement for executing the one or more workgroups and based on a current state of the compute unit.

19. The compute unit of claim 18, wherein the processing circuitry is configured to:
prior to executing the one or more workgroups, reconfigure a proportion of the shared memory to the first level cache based on the memory configuration requirement.

20. The compute unit of claim 18, wherein the current state is an idle state indicating that the compute unit is not currently executing a workgroup or an underutilized state indicating that the compute unit has bandwidth to execute an additional workgroup.
